(19) United States
(12) Patent Application Publication
(10) Pub. No.: US 2005/0008287 A1
(43) Pub. Date: Jan. 13, 2005

(54) Modular dispersion compensator

(75) Inventor: David L. Wilson, Little Silver, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Red SKy Systems, Inc.

(21) Appl. No.: 10/619,094

(22) Filed: Jul. 11, 2003

(51) Int. Cl. G02B 6/26

(52) U.S. Cl. 385/27; 385/24

(57) ABSTRACT

A method and apparatus is provided to compensate for dispersion of a WDM optical signal. The method begins by directing a WDM optical signal having a prescribed bandwidth to a first dispersion compensating element and substantially compensating, with the first dispersion compensating element, each wavelength in the WDM optical signal for dispersion at a prescribed wavelength within a first sub-band of the prescribed bandwidth. The method continues by directing to a second dispersion compensating element wavelengths received from the first dispersion compensating element outside the first sub-band and substantially compensating, with the second dispersion compensating element, each wavelength received from the first dispersion compensating element for dispersion at a prescribed wavelength within a second sub-band of the prescribed bandwidth; The wavelengths received from the second dispersion compensating element are combined within the second sub-band of the prescribed bandwidth with the wavelengths received from the first dispersion compensating element within the first sub-band.

### FIELD OF THE INVENTION

The present invention relates generally to WDM optical transmission systems, and more particularly to a method and apparatus for providing dispersion compensation in a WDM optical transmission system.

### BACKGROUND OF THE INVENTION

In recent years, Wavelength Division Multiplexed (WDM) and Dense Wavelength Division Multiplexed (DWDM) optical transmission systems have been increasingly deployed in optical networks. Although DWDM optical transmission systems have increased the speed and capacity of optical networks, the performance of such systems, especially those providing bit rates of 10 Gb/s or more, has traditionally been limited by various factors such as chromatic dispersion and the non-linearity in an optical fiber's refractive index, which can cause spectral broadening of optical pulses and degrade the transmission of high speed optical signals. Because such optical signal degradation tends to accumulate along transmission paths, chromatic dispersion and non-linearity can significantly limit the transmission distance of high speed optical signals.

Chromatic dispersion refers to the fact that different wavelengths of light pass through an optical fiber at different speeds, thereby causing a pulse of light propagating through the optical fiber to broaden. Chromatic dispersion is often characterized as first, second and third order dispersion. First order dispersion is the rate of change of the refractive index with respect to wavelength in the fiber. First order dispersion is also referred to as group velocity. Second order dispersion is the rate of change of the first order dispersion with respect to wavelength. Second order dispersion produces the pulse broadening. Third order dispersion is the rate of change of broadening with respect to a change in wavelength. This is often referred to as the dispersion slope.

Several solutions have been proposed to mitigate the effects of dispersion in transmission fibers. One technique involves the use of a compensating optical fiber having an appropriate length and which has a dispersion that is opposite to the dispersion characteristic of the transmission fiber. As a result, the dispersion in the transmission fiber is substantially canceled by the total dispersion in the compensating fiber. Since dispersion is wavelength dependent, the amount of dispersion compensation that is needed differs from wavelength to wavelength. WDM and DWDM optical transmission systems therefore typically provide dispersion compensation to each wavelength individually. Since this solution can be difficult and expensive to implement, dispersion compensation is sometimes performed on groups of wavelengths so that each wavelength within a group receives the same amount of dispersion compensation.

FIG. 1 shows a known chromatic dispersion compensator 105 for performing dispersion compensation on groups of wavelengths. In operation, the dispersion compensator first splits the bandwidth of the optical spectrum into a series of bands, equalizes the dispersion of each band individually, and finally recombines the signals onto a common path for continued transmission. In FIG. 1, the signals reach the compensator on fiber path 201 and enter a 1×N optical splitter 203, which divides the power of the optical signal onto output paths 209₁, 209₂, 209₃, . . . 209_{N}. The signals propagating along the N output paths respectively enter optical band-pass filters 204₁, 204₂, 204₃, . . . 204_{N} with a center wavelength of λ₁, λ₂, λ₃, . . . λ_{N}, respectively. The optical bandpass filters 204 separate the usable bandwidth into N distinct bands. The signals emerging from bandpass filters 204₁, 204₂, 204₃, . . . 204_{N} each enter a respective dispersion equalizing fiber 205₁, 205₂, 205₃, . . . 205_{N} and possibly loss elements 208₁, 208₂, 208₃, . . . 208_{N}. The signals are subsequently recombined in coupler 206 before exiting the dispersion compensator on fiber 207. The dispersion in each of the plurality of compensating fibers 205₁, 205₂, 205₃, . . . 205_{N} is selected so that the average chromatic dispersion of the concatenated transmission spans 104 upstream from the dispersion compensator 105 and the equalizing sections 202 and 205 are substantially returned to zero at each of the center wavelengths λ_{N}. Additional details concerning the dispersion compensator shown in FIG. 1 may be found in U.S. Pat. No. 6,137,604.

One limitation of the aforementioned known dispersion compensator is that it is difficult to increase the number of wavelength bands as additional channels are added to increase system capacity sometime after the dispersion compensator is initially installed and operational. For example, the splitter 203 as initially deployed must include the maximum number of anticipated output paths 209 that eventually may be required. That is, if the dispersion compensator is initially required to provide only N bands, but if it is used in a transmission system that is ultimately anticipated to provide N+x bands, the splitter 203 must be deployed with N+x output paths 209 even though x of them will initially go unused. Likewise, N+x equalizing fibers 208 need to be provided even though only N of them are initially required.

Another limitation of this approach is that each dispersion equalizing fiber 205ᵢ must supply the total amount of compensation required by each band i, even though this amount is only incrementally different from that required by adjacent bands.

Accordingly, it would be desirable to provide a dispersion compensator in which modular functionality can be provided so that its capacity can be increased as needed in a relatively easy and inexpensive manner, and in which the amount of equalizing fiber required can be reduced.

### SUMMARY OF THE INVENTION

In accordance with the present invention, a dispersion compensator is provided that includes a first plurality of dispersion compensating modules. A first of the dispersion compensating modules includes a first input port for receiving a WDM optical signal having a prescribed bandwidth, a second input port, and first and second output ports. A dispersion compensating element is coupled to the first input port for substantially compensating each wavelength in the WDM optical signal for dispersion at a prescribed wavelength within a first sub-band of said prescribed bandwidth. A first wavelength selective arrangement is provided to (i) direct to the second output port wavelengths received from the dispersion compensating element outside the first sub-band and (ii) direct to the first output port wavelengths received from the second input port and wavelengths received from the dispersion compensating element within the first sub-band. A second of the dispersion compensating modules includes a third input port optically coupled to the second output port of the first dispersion compensating module for receiving the wavelengths of the WDM optical signal outside the first sub-band, a fourth input port, and third and fourth output ports. The third output port is coupled to the second input port of the first dispersion compensating module. A second dispersion compensating element is coupled to the third input port for substantially compensating each wavelength received from the third input port for dispersion at a prescribed wavelength within a second sub-band of the prescribed bandwidth. A second wavelength selective arrangement (i) directs to the fourth output port wavelengths received from the second dispersion compensating element outside the second sub-band of said prescribed bandwidth and (ii) directs to the third output port wavelengths received from the fourth input port and wavelengths received from the second dispersion compensating element within the second sub-band.

In accordance with another aspect of the invention, the prescribed wavelength in the first sub-band for which dispersion is substantially compensated is a center wavelength of the first sub-band.

In accordance with another aspect of the invention, the prescribed wavelength in the second sub-band for which dispersion is substantially compensated is a center wavelength of the second sub-band.

In accordance with another aspect of the invention, the first wavelength selective arrangement includes a pair of filter elements each reflecting the wavelengths received from the first dispersion compensating element within the first sub-band and transmitting the wavelengths received from the first dispersion compensating element outside the first sub-band and the wavelengths received from the second input port.

In accordance with another aspect of the invention, the second wavelength selective arrangement includes a pair of filter elements each reflecting the wavelengths received from the second dispersion compensating element within the second sub-band and transmitting the wavelengths received from the second dispersion compensating element outside the second sub-band and the wavelengths received from the third input port.

In accordance with another aspect of the invention, the first plurality of dispersion compensating modules includes N dispersion compensating modules, where N is an integer equal to a number of wavelength bands into which the prescribed bandwidth is to be divided.

In accordance with another aspect of the invention, the dispersion compensating elements are single mode fibers.

In accordance with another aspect of the invention, the dispersion compensating elements are fiber diffraction gratings.

In accordance with another aspect of the invention, a gain or loss element is coupled to the dispersion compensating element of least one of the first and second dispersion compensating modules.

In accordance with another aspect of the invention, a gain or loss element is coupled to the dispersion compensating element of each of the first and second dispersion compensating modules.

In accordance with another aspect of the invention, a common dispersion compensating element is provided for translating an average zero dispersion wavelength of the prescribed bandwidth to one end of the prescribed bandwidth. The common dispersion compensating element couples the first input port of the first dispersion compensating module to the dispersion compensating element of the first dispersion compensating module.

In accordance with another aspect of the invention, a method is provided to compensate for dispersion of a WDM optical signal. The method begins by directing a WDM optical signal having a prescribed bandwidth to a first dispersion compensating element and substantially compensating, with the first dispersion compensating element, each wavelength in the WDM optical signal for dispersion at a prescribed wavelength within a first sub-band of the prescribed bandwidth. The method continues by directing to a second dispersion compensating element wavelengths received from the first dispersion compensating element outside the first sub-band and substantially compensating, with the second dispersion compensating element, each wavelength received from the first dispersion compensating element for dispersion at a prescribed wavelength within a second sub-band of the prescribed bandwidth; The wavelengths received from the second dispersion compensating element are combined within the second sub-band of the prescribed bandwidth with the wavelengths received from the first dispersion compensating element within the first sub-band.

### BRIEF DESCRIPTION OF THE DRAWINGS

FIG. 1 shows a known chromatic dispersion compensator 105 for performing dispersion compensation on groups of wavelengths.

FIG. 2 shows the dispersion exhibited by a transmission path over the bandwidth λ₀-λₙ, which in this example is a linear function of wavelength.

FIG. 3 shows one embodiment of a modular dispersion compensator constructed in accordance with the present invention.

### DETAILED DESCRIPTION

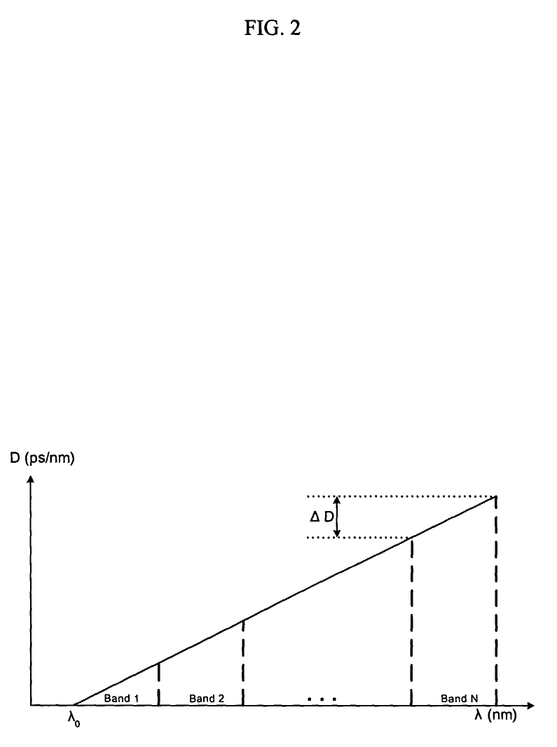

For purposes of illustration only and not as a limitation on the invention, the present invention will be described in terms of a transmission path that exhibits the dispersion shown in FIG. 2 over the bandwidth λ₀-λₙ. In this example the dispersion is a linear function of wavelength. Also, the average zero dispersion wavelength λ₀ of the transmission fiber is located at one end of the transmission band so that the dispersion compensation that must be provided to the individual channels is all of the same sign, either positive or negative. The bandwidth is divided into N bands to which dispersion compensation is to be provided. The dispersion compensation to be provided to each wavelength in a given band is an integral multiple of some fixed increment. For instance, if ΔD is the change in dispersion over the width of each band, then optimum compensation involves compensating each wavelength within the band with a value of −ΔD/2 for band 1, −(3/2) ΔD for band 2, −(5/2) ΔD for band 3, and so on. In this way the dispersion at the center wavelength of each band is zeroed.

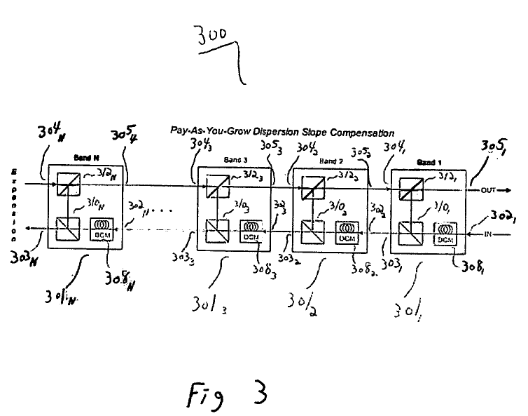

FIG. 3 shows one embodiment of a modular dispersion compensator 300 constructed in accordance with the present invention. The dispersion compensator 300 includes a concatenation of dispersion compensating modules 301₁, 301₂, . . . 301_{N}. That is, the number of dispersion compensating modules 301 that are provided is equal to the number of wavelength bands to which dispersion compensation is to be provided. Each dispersion compensating module 301 is a four port device that includes an input port 302, a partially compensating output port 303, a return port 304, and a compensating output port 305.

With respect to any given module 301ᵢ, the WDM signal to which dispersion compensation is to be provided is initially received by the module on input port 302ᵢand is directed to dispersion compensating element 308ᵢ. Dispersion compensating element 308ᵢ provides an amount of dispersion compensation required to impart the incremental increase in compensation that is required for band i. For example, assuming as in FIG. 2 that the change in dispersion over the width of each band is ΔD and that the dispersion at the center wavelength of each band is to be zeroed, the dispersion compensating element 308₁ in module 301₁ should provide a compensation of −ΔD/2. Likewise, the dispersion compensating elements 308₂-308ₙ each provide a compensation of −ΔD.

In the embodiment of the invention shown in FIG. 3 the dispersion compensating elements 308 are single-mode fibers. Of course, those of ordinary skill in the art will recognize that many other optical devices may be employed to provide the necessary dispersion compensation. For example, fiber diffraction gratings may be used instead of single-mode fibers.

After traversing dispersion compensating element 308ᵢ, the WDM signal is directed to a first bandpass filter 310ᵢ. First bandpass filter 310ᵢ is configured to reflect the wavelengths in band i and transmit therethrough the wavelengths in the remaining bands (i+1) to N. The wavelengths reflected by the first bandpass filter 310ᵢ are directed to a second bandpass filter 312ᵢ that reflects these same wavelengths (i.e., the wavelengths in band i) to compensating output port 305. That is, the first and second bandpass filters 310ᵢ and 312ᵢ have the same transmission bands and the same reflection bands. The wavelengths transmitted through the first filter 310ᵢ are directed to partially compensating output port 303ᵢ.

The partially compensating output port 303ᵢ of module 301ᵢ is optically coupled to the input port 302₍ᵢ₊₁₎ of module 301₍ᵢ₊₁₎. In this way module 301₍ᵢ₊₁₎ receives the wavelengths in wavebands (i+1) to N so that a dispersion compensation of −ΔD is imparted to each wavelength by dispersion compensating element 308(i+1). The operation of module 301₍ᵢ₊₁₎ continues in a manner similar to that described above in connection with module 301ᵢ. That is, first and second bandpass filters 310₍ᵢ₊₁₎ and 312₍ᵢ₊₁₎ reflect the wavelengths in band (i+1) to compensating output port 305₍ᵢ₊₁₎ and transmit to partially compensating output port 303₍ᵢ₊₁₎ the wavelengths in bands (i+2) to N. The second filter 310₍ᵢ₊₁₎ reflects the wavelengths in band (i+1) to compensating output port 305₍ᵢ₊₁₎, which in turn is optically coupled to the return port 304ᵢ of module 301ᵢ so that the wavelengths in band (i+1) are directed to compensating output 305ᵢ via second bandpass filter 312ᵢ.

In summary, dispersion compensating module 301ᵢ imparts an increment of dispersion compensation that serves as the final increment required by the wavelengths in band i and as one part of the total dispersion compensation required by the wavelengths in bands (i+1) to N. The wavelengths in band i are therefore directed to compensating output port 305ᵢ so that they can be ultimately passed to the compensating output port 305₁ of module 301₁, where they exit the dispersion compensator 300. The wavelengths in bands (i+1) are directed to partially compensating output port 303ᵢ so that they can be received by successive modules for receiving additional dispersion compensation.

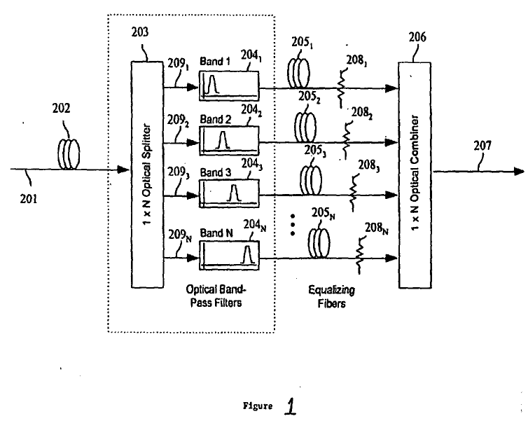

One important advantage of the present invention is that individual modules 301 can be added to the dispersion compensator 300 as they are needed. For example, if only the wavelengths in band 1 are initially being used, then only module 301₁ needs to be installed. As successive bands are populated, the corresponding modules 301₂, 301₃ . . . 301_{N} can be added to the dispersion compensator 300. Another important advantage is that because the modules are cascaded so that any given dispersion compensating module imparts dispersion compensation to all wavelengths that traverse subsequent or downstream modules, the total amount of dispersion compensating fiber that is required is substantially reduced in comparison to the dispersion compensator shown in FIG. 1.

In some embodiments of the invention the individual dispersion compensating modules 301ᵢ may each include a loss or gain element (not shown) to facilitate gain equalization within the bands. For example, the loss or gain elements may be used to equalize the received signal-to-noise ratio of the wavelengths.

In some cases the wavelengths may be so closely spaced (e.g., 50 GHz or less) that bandpass filters that can satisfactorily separate adjacent wavelengths may be difficult to obtain. In this case the modular dispersion compensator may be preceded by a deinterleaver that separates the even and odd wavelengths onto different output paths, effectively doubling the channel spacing on the each output path. In this arrangement two of the modulator dispersion compensators 300 are employed, each receiving the wavelengths from one of the output paths of the deinterleaver. The dispersion compensated output signals from the two modulator dispersion compensators are then directed to the inputs of an interleaver so that the even and odd wavelengths are recombined.

If the average zero dispersion wavelength λ₀ of the transmission fiber is located within the transmission band instead of at the end as in FIG. 1, a common dispersion compensating element may be located prior to the first dispersion compensating module 301₁. In way all the wavelengths will experience the dispersion compensation that is imparted by the common dispersion compensating element. The dispersion of the common dispersion compensating element has the correct sign and magnitude to move the average zero dispersion wavelength λ₀ to one end of the transmission band so that the dispersion compensation that must be provided to each wavelength is all of the same sign. In some cases the common dispersion compensating element may be located in the first dispersion compensating module 301₁.

Alternatively, instead of a common dispersion compensating element two modular dispersion compensators may be provided, each of which provides dispersion compensation of the opposite sign. In this case a wavelength dependent optical splitter is employed, which splits the transmission band into two parts, each of which require dispersion compensation of the opposite sign. The outputs from the wavelength dependent splitter direct each part of the transmission band to the input of the appropriate modular dispersion compensator.

1. A dispersion compensator, comprising:
a first plurality of dispersion compensating modules, a first of said dispersion compensating modules including:
a first input port for receiving a WDM optical signal having a prescribed bandwidth;
a second input port;
first and second output ports;
a dispersion compensating element coupled to the first input port for substantially compensating each wavelength in the WDM optical signal for dispersion at a prescribed wavelength within a first sub-band of said prescribed bandwidth;
a first wavelength selective arrangement (i) directing to the second output port wavelengths received from the dispersion compensating element outside the first sub-band and (ii) directing to the first output port wavelengths received from the second input port and wavelengths received from the dispersion compensating element within the first sub-band;
a second of said dispersion compensating modules including:
a third input port optically coupled to the second output port of the first dispersion compensating module for receiving the wavelengths of the WDM optical signal outside the first sub-band;
a fourth input port;
third and fourth output ports, said third output port being coupled to the second input port of the first dispersion compensating module;
a second dispersion compensating element coupled to the third input port for substantially compensating each wavelength received from the third input port for dispersion at a prescribed wavelength within a second sub-band of said prescribed bandwidth;
a second wavelength selective arrangement (i) directing to the fourth output port wavelengths received from the second dispersion compensating element outside the second sub-band of said prescribed bandwidth and (ii) directing to the third output port wavelengths received from the fourth input port and wavelengths received from the second dispersion compensating element within the second sub-band.

2. The dispersion compensator of claim 1 wherein the prescribed wavelength in the first sub-band for which dispersion is substantially compensated is a center wavelength of the first sub-band.

3. The dispersion compensator of claim 2 wherein the prescribed wavelength in the second sub-band for which dispersion is substantially compensated is a center wavelength of the second sub-band.

4. The dispersion compensator of claim 1 wherein the first wavelength selective arrangement includes a pair of filter elements each reflecting the wavelengths received from the first dispersion compensating element within the first sub-band and transmitting the wavelengths received from the first dispersion compensating element outside the first sub-band and the wavelengths received from the second input port.

5. The dispersion compensator of claim 1 wherein the second wavelength selective arrangement includes a pair of filter elements each reflecting the wavelengths received from the second dispersion compensating element within the second sub-band and transmitting the wavelengths received from the second dispersion compensating element outside the second sub-band and the wavelengths received from the third input port.

6. The dispersion compensator of claim 1 wherein the first plurality of dispersion compensating modules includes N dispersion compensating modules, where N is an integer equal to a number of wavelength bands into which said prescribed bandwidth is to be divided.

7. The dispersion compensator of claim 1 wherein said dispersion compensating elements are single mode fibers.

8. The dispersion compensator of claim 1 wherein said dispersion compensating elements are fiber diffraction gratings.

9. The dispersion compensator of claim 1 further comprising a gain or loss element coupled to the dispersion compensating element of least one of the first and second dispersion compensating modules.

10. The dispersion compensator of claim 1 further comprising a gain or loss element coupled to the dispersion compensating element of each of the first and second dispersion compensating modules.

11. The dispersion compensator of claim 1 further comprising a second plurality of dispersion compensating modules, a first of said dispersion compensating modules including:
a first input port for receiving a WDM optical signal having a prescribed bandwidth;
a second input port;
first and second output ports;
a dispersion compensating element coupled to the first input port for substantially compensating each wavelength in the WDM optical signal for dispersion at a prescribed wavelength within a first sub-band of said prescribed bandwidth;
a first wavelength selective arrangement (i) directing to the second output port wavelengths received from the dispersion compensating element outside the first sub-band and (ii) directing to the first output port wavelengths received from the second input port and wavelengths received from the dispersion compensating element within the first sub-band;
a second of said dispersion compensating modules including:
a third input port optically coupled to the second output port of the first dispersion compensating module for receiving the wavelengths of the WDM optical signal outside the first sub-band;
a fourth input port;
third and fourth output ports, said third output port being coupled to the second input port of the first dispersion compensating module;
a second dispersion compensating element coupled to the third input port for substantially compensating each wavelength received from the third input port for dispersion at a prescribed wavelength within a second sub-band of said prescribed bandwidth;
a second wavelength selective arrangement (i) directing to the fourth output port wavelengths received from the second dispersion compensating element outside the second sub-band of said prescribed bandwidth and (ii) directing to the third output port wavelengths received from the fourth input port and wavelengths received from the second dispersion compensating element within the second sub-band;
a deinterleaver having a first output coupled to the first input port of the first dispersion compensating module in the first plurality of dispersion compensating modules and a second ouput coupled to first input port of the first dispersion compensating module in the second plurality of dispersion compensating modules; and
an interleaver having a first input coupled to the first output port of the second dispersion compensating element in the first plurality of dispersion compensating modules and a second input coupled to the first output port of the second dispersion compensating module in the second plurality of dispersion compensating modules.

12. The dispersion compensator of claim 6 further comprising a second plurality of dispersion compensating modules wherein the second plurality of dispersion compensating modules includes N dispersion compensating modules, where N is an integer equal to a number of wavelength bands into which said prescribed bandwidth is to be divided., a first of said dispersion compensating modules including:
a first input port for receiving a WDM optical signal having a prescribed bandwidth;
a second input port;
first and second output ports;
a dispersion compensating element coupled to the first input port for substantially compensating each wavelength in the WDM optical signal for dispersion at a prescribed wavelength within a first sub-band of said prescribed bandwidth;
a first wavelength selective arrangement (i) directing to the second output port wavelengths received from the dispersion compensating element outside the first sub-band and (ii) directing to the first output port wavelengths received from the second input port and wavelengths received from the dispersion compensating element within the first sub-band;
a second of said dispersion compensating modules including:
a third input port optically coupled to the second output port of the first dispersion compensating module for receiving the wavelengths of the WDM optical signal outside the first sub-band;
a fourth input port;
third and fourth output ports, said third output port being coupled to the second input port of the first dispersion compensating module;
a second dispersion compensating element coupled to the third input port for substantially compensating each wavelength received from the third input port for dispersion at a prescribed wavelength within a second sub-band of said prescribed bandwidth;
a second wavelength selective arrangement (i) directing to the fourth output port wavelengths received from the second dispersion compensating element outside the second sub-band of said prescribed bandwidth and (ii) directing to the third output port wavelengths received from the fourth input port and wavelengths received from the second dispersion compensating element within the second sub-band;
a deinterleaver having a first output coupled to the first input port of the first dispersion compensating module in the first plurality of dispersion compensating modules and a second output coupled to first input port of the first dispersion compensating module in the second plurality of dispersion compensating modules; and
an interleaver having a first input coupled to the first output port of the Nth dispersion compensating element in the first plurality of dispersion compensating modules and a second input coupled to the first output port of the nth dispersion compensating module in the second plurality of dispersion compensating modules.

13. The dispersion compensator of claim 1 further comprising a common dispersion compensating element for translating an average zero dispersion wavelength of the prescribed bandwidth to one end of the prescribed bandwidth, said common dispersion compensating element coupling the first input port of the first dispersion compensating module to said dispersion compensating element of the first dispersion compensating module.

14. The dispersion compensator of claim I further comprising a second plurality of dispersion compensating modules, a first of said dispersion compensating modules including:
a first input port for receiving a WDM optical signal having a prescribed bandwidth;
a second input port;
first and second output ports;
a dispersion compensating element coupled to the first input port for substantially compensating each wavelength in the WDM optical signal for dispersion at a prescribed wavelength within a first sub-band of said prescribed bandwidth;
a first wavelength selective arrangement (i) directing to the second output port wavelengths received from the dispersion compensating element outside the first sub-band and (ii) directing to the first output port wavelengths received from the second input port and wavelengths received from the dispersion compensating element within the first sub-band;
a second of said dispersion compensating modules including:
a third input port optically coupled to the second output port of the first dispersion compensating module for receiving the wavelengths of the WDM optical signal outside the first sub-band;
a fourth input port;
third and fourth output ports, said third output port being coupled to the second input port of the first dispersion compensating module;
a second dispersion compensating element coupled to the third input port for substantially compensating each wavelength received from the third input port for dispersion at a prescribed wavelength within a second sub-band of said prescribed bandwidth;
a second wavelength selective arrangement (i) directing to the fourth output port wavelengths received from the second dispersion compensating element outside the second sub-band of said prescribed bandwidth and (ii) directing to the third output port wavelengths received from the fourth input port and wavelengths received from the second dispersion compensating element within the second sub-band;
a splitter having a first output coupled to the first input port of the first dispersion compensating module in the first plurality of dispersion compensating modules and a second output coupled to first input port of the first dispersion compensating module in the second plurality of dispersion compensating modules; and
wherein said dispersion compensating elements in the first plurality of dispersion compensating modules provide dispersion compensation that is opposite in sign to dispersion compensation provided by said dispersion compensating elements in the second plurality of dispersion compensating modules.

15. A method for compensating for dispersion of a WDM optical signal, comprising:
directing a WDM optical signal having a prescribed bandwidth to a first dispersion compensating element;
substantially compensating, with the first dispersion compensating element, each wavelength in the WDM optical signal for dispersion at a prescribed wavelength within a first sub-band of said prescribed bandwidth;
directing to a second dispersion compensating element wavelengths received from the first dispersion compensating element outside the first sub-band;
substantially compensating, with the second dispersion compensating element, each wavelength received from the first dispersion compensating element for dispersion at a prescribed wavelength within a second sub-band of said prescribed bandwidth; and
combining wavelengths received from the second dispersion compensating element within the second sub-band of said prescribed bandwidth with the wavelengths received from the first dispersion compensating element within the first sub-band.

16. The method of claim 15 further comprising the steps of:
directing wavelengths received from the second dispersion compensating element outside the first and second sub-bands to a third dispersion compensating element;
substantially compensating, with the third dispersion compensating element, each wavelength received from the second dispersion compensating element for dispersion at a prescribed wavelength within a third sub-band of said prescribed bandwidth; and
combining the wavelengths received from the third dispersion compensating element within the third sub-band of said prescribed wavelength with the wavelengths received from the second dispersion compensating element within the second sub-band of said prescribed bandwidth, and with the wavelengths received from the first dispersion compensating element within the first sub-band.

17. The method of claim 15 wherein the prescribed wavelength in the first sub-band for which dispersion is substantially compensated is a center wavelength of the first sub-band.

18. The method of claim 17 wherein the prescribed wavelength in the second sub-band for which dispersion is substantially compensated is a center wavelength of the second sub-band.

19. The method of claim 15 wherein said directing step is performed by a first filter element.

20. The method of claim 15 wherein said combining step is performed by a second filter element.

21. The method of claim 19 wherein said first filter element transmits said wavelengths received from the first dispersion compensating element outside the first sub-band and reflects the wavelengths received from the first dispersion compensating element within the first sub-band.

22. The method of claim 20 wherein said second filter element transmits the wavelengths received from the second dispersion compensating element within the second sub-band of said prescribed bandwidth and reflects the wavelengths received from the first dispersion compensating element within the first sub-band.

23. The method of claim 15 wherein said first and second dispersion compensating elements are single mode fibers.

24. The method of claim 15 wherein said first and second dispersion compensating elements are fiber diffraction gratings.

25. The method of claim 15 further comprising the steps of imparting gain or loss to the first sub-band of wavelengths and imparting gain or loss to the second sub-band of wavelengths.

26. The method of claim 15 further comprising the step of translating an average zero dispersion wavelength of the prescribed bandwidth to one end of the prescribed bandwidth prior to directing the WDM optical signal to the first dispersion compensating element.

27. A method for compensating for dispersion of a WDM optical signal, comprising:
deinterleaving a WDM optical signal having a prescribed bandwidth to provide even and odd optical signals;
directing the even optical signal to a first dispersion compensating element;
substantially compensating, with the first dispersion compensating element, each wavelength in the even optical signal for dispersion at a prescribed wavelength within a first sub-band of said prescribed bandwidth;
directing to a second dispersion compensating element wavelengths received from the first dispersion compensating element outside the first sub-band;
substantially compensating, with the second dispersion compensating element, each wavelength received from the first dispersion compensating element for dispersion at a prescribed wavelength within a second sub-band of said prescribed bandwidth;
combining wavelengths received from the second dispersion compensating element within the second sub-band of said prescribed bandwidth with the wavelengths received from the first dispersion compensating element within the first sub-band to form a dispersion compensated even optical signal;
directing the odd optical signal to a third dispersion compensating element;
substantially compensating, with the third dispersion compensating element, each wavelength in the odd optical signal for dispersion at a prescribed wavelength within a third sub-band of said prescribed bandwidth;
directing to a fourth dispersion compensating element wavelengths received from the third dispersion compensating element outside the third sub-band;
substantially compensating, with the fourth dispersion compensating element, each wavelength received from the third dispersion compensating element for dispersion at a prescribed wavelength within a fourth sub-band of said prescribed bandwidth;
combining wavelengths received from the fourth dispersion compensating element within the fourth sub-band of said prescribed bandwidth with the wavelengths received from the third dispersion compensating element within the third sub-band to form a dispersion compensated odd optical signal;
interleaving said dispersion compensated even and odd optical signals.

28. The method of claim 27 wherein the prescribed wavelength in the first sub-band for which dispersion is substantially compensated is a center wavelength of the first sub-band.

29. The method of claim 28 wherein the prescribed wavelength in the second sub-band for which dispersion is substantially compensated is a center wavelength of the second sub-band.

30. The method of claim 27 wherein the step of directing the even optical signal is performed by a first filter element.

31. The method of claim 27 wherein the step of combining wavelengths to form a dispersion compensated even optical signal is performed by a second filter element.

32. The method of claim 30 wherein said first filter element transmits said wavelengths received from the first dispersion compensating element outside the first sub-band and reflects the wavelengths received from the first dispersion compensating element within the first sub-band.

33. The method of claim 31 wherein said second filter element transmits the wavelengths received from the second dispersion compensating element within the second sub-band of said prescribed bandwidth and reflects the wavelengths received from the first dispersion compensating element within the first sub-band.

34. The method of claim 27 wherein said first and second dispersion compensating elements are single mode fibers.

35. The method of claim 27 wherein said first and second dispersion compensating elements are fiber diffraction gratings.

36. The method of claim 27 further comprising the steps of imparting gain or loss to the first sub-band of wavelengths and imparting gain or loss to the second sub-band of wavelengths.
